(19) United States
(12) Patent Application Publication
(10) Pub. No.: US 2008/0159313 A1
(43) Pub. Date: Jul. 3, 2008

(54) Interworking policy and charging control and network address translator

(75) Inventor: Juha Rasanen, Espoo (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 12/000,401

(22) Filed: Dec. 12, 2007

Related U.S. Application Data
(60) Provisional application No. 60/877,397, filed on Dec. 28, 2006.

(51) Int. Cl. H04L 12/28

(52) U.S. Cl. 370/401

(57) ABSTRACT

A system and method set specific communication parameters, with the method including identifying a communication relay for allocating addresses. A STUN communication relay can be directed to a specific type of communication such as IMS-specific communication. The communication server ID information is then transmitted to a network, with the communication server being identified as IMS specific. Media flow to and from the communication server for non-specific sessions is therefore blocked. Addresses are allocated by the communication server to user equipment only for specific sessions. Optionally, outbound/uplink traffic may routed from the relay and inbound/downlink traffic may be routed to IMS-specific IP addresses by a policy and charging enforcement function. Also, a time-out unit may re-configure the relay to enable non-IMS sessions if there has been no IMS traffic for a period of time.

### CROSS REFEFERENCE TO RELATED APPLICATIONS

The present application claims priority under 35 U.S.C. §119(e) to U.S. Provisional Patent Application No. 60/877,394 filed on Dec. 28, 2006, the subject matter of which is hereby incorporated by reference in full.

### BACKGROUND OF THE INVENTION

1. Field of the Invention

The present invention generally relates to a network address translator, sometimes referred to as a NAT, in multimedia communication networks. In particular, the invention is directed to traversal of a network address translator, and policy and charging control relating to access of IP multimedia subsystems.

2. Description of the Related Art

A significant amount of development and standardization is occurring with respect to various communication networks and systems. For example, the third generation partnership project (3GPP) has standardized an application level gateway (ALG) and network address translation (NAT) gateway based method for traversal of uncontrolled access network address translation. According to the standard as currently proposed, when a device or devices that perform network address translation (or port translation) are located between user equipment and a policy call session control function performing translation of signaling and media packets, particular procedures are defined. Additionally, when Internet Protocol (IP) address translation or port translation is required between an IP connectivity access network (IPCAN) and an IP Multimedia Subsystem (IMS) domain on the media path only, IMS service provisioning must be properly defined. Referring to FIG. 1, a general reference model is provided for IMS access when signaling and media packets are traversing network address translation devices. The dashed lines represent optional functionality; the transport of media is subject to policy enforcement.

### SUMMARY OF THE INVENTION

These and other needs are addressed in certain embodiments of the present invention, as described below.

In one embodiment, the invention comprises a method of setting specific communication parameters, with the method comprising identifying a communication relay for allocating addresses. The method can then comprise configuring a communication relay/server to be directed to a specific type of communication such as IMS-specific communication. The communication server ID information is then transmitted to a network, with the communication server being identified as IMS specific. Media flow to and from the communication server for non-IMS specific sessions are therefore blocked since these other sessions do not receive IP addresses. Instead, addresses are allocated by the communication server to user equipment only for the IMS-specific sessions.

In another configuration, a method according to the invention comprises configuring a communication relay such as a STUN relay to use a public address area for IMS-specific functions. The relay is then advertised to other network components as being an IMS-specific relay. Outbound/uplink traffic is routed from the relay via a policy and charging enforcement function. Inbound/downlink traffic is routed to IMS-specific IP addresses by the policy and charging enforcement function and through the STUN relay.

A network component according to the invention can comprise an identifying unit for identifying a function-specific relay, such as a STUN relay, for allocating addresses. A configuring unit configures the identified server to be IMS specific. A transmitting unit can transmit or advertise the server as being IMS specific. A blocking unit can then block media flow for non-IMS sessions, and allocating unit can allocate IP addresses from an address area to the user equipment only for IMS sessions.

In another embodiment, a network element according to the invention can include a configuration unit which configures a STUN relay to use a public/external address area for IMS sessions only. An advertising unit is configured to advertise the STUN relay as IMS specific. An outbound routing unit (in the access network border) routes outbound/uplink traffic through the STUN relay to a policy and charging enforcement function and further to a border gateway. An inbound routing unit routes inbound/downlink traffic which has the destination addresses in the address area to the STUN relay through a policy and charging enforcement function.

In certain embodiments of the invention, a time-out unit may re-configure the STUN relay to enable non-IMS sessions if there has been no IMS traffic for a period of time.

As a result of the various configurations of the invention, effective and efficient handling of IMS traffic can occur, without requiring a user equipment to first send a media packet in order to have the network address translation device allocate a particular address, and also for modifying the gateway to obtain the address and use it as a destination address for downlink media packets. Additionally, the configurations of the present invention can reduce or eliminate the need for various applications to send keep-alive messages when there is no traffic. Additionally, overall network congestion can be further reduced and transmission delays minimized due to the fact that there is no need to loop a media pass via a home network.

### BRIEF DESCRIPTION OF THE DRAWINGS

FIG. 1 illustrates an example of a reference model for IMS access;

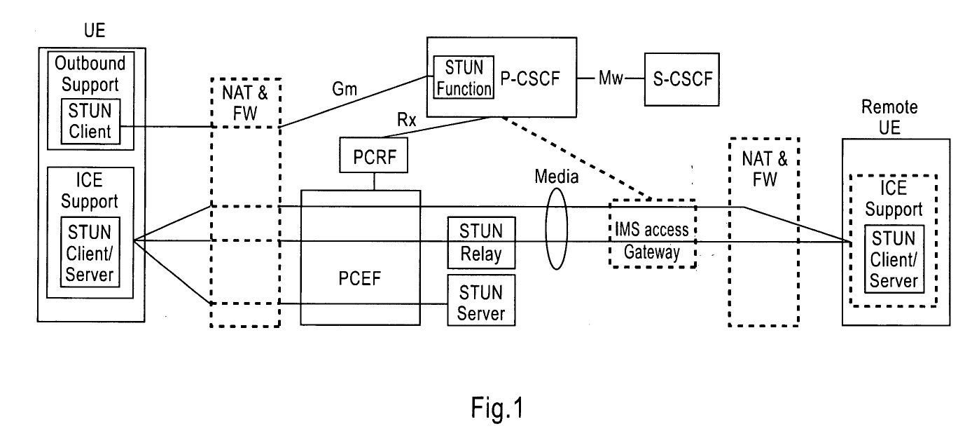

FIG. 2 illustrates an alternative reference model;

FIG. 3 illustrates a flow chart of a method according to the invention;

FIG. 4 illustrates an alternative embodiment of the invention;

FIG. 5 illustrates a block diagram of elements of an embodiment of the invention; and

FIG. 6 illustrates a block diagram of another embodiment of the invention.

### DETAILED DESCRIPTION OF THE PREFERRED EMBODIMENTS

In network communications using a system such as that which is defined in 3GPP, the SIP (session initiation protocol)/SDP (session description protocol) fields contain the private domain IP address of the user equipment (UE) while the packets come through the network address translation (NAT) device and the sender appears to be the public IP address allocated by the network address translation device. As a result of this configuration, the application level gateway functionality in connection with the application function/proxy call session control function (AF/P-CSCF) can request public addresses from the network address translation gateway, and modify the SIP/SDP accordingly prior to sending the message forward. The application level gateway/application function/proxy call session control function (ALG/AF/P-CSCF) can initiate proper security measures such as IP SEC tunnel for the SIP signaling to traverse the network address translation device.

In this configuration, however, the user equipment sends a media packet first, before the user equipment can then receive media packets, in order to enable the network address translation device to allocate an address and to let the network address translation gateway obtain the address and to use it as a destination address for downloading media packets. The network address translation device releases the allocated address if there is no traffic. Applications, however, may need to send keep-alive messages in order to prevent the address data from being timed-out. Additionally, when the user equipment is using visited network services, a media packet is looped via home network when the home networks proxy call session control function is used.

According to embodiments certain of the present invention, however, network address translation traversal methodology can be enhanced with interactive connectivity establishment (ICE) and an interactive connectivity establishment mechanism based on the use of a simple traversal of user datagram protocol (UDP) through network address translation (STUN) devices and a STUN relay. ICE-based usage of a STUN server and a STUN relay server in networks and relevant clients at user equipment are described below. According to these methods, user equipment can get an external/public IP address by sending an inquiry to a STUN server or a STUN relay server, and inserting the external/public address in the SIP/SDP level. This methodology can make the application level gateway and network address translation gateway functionality redundant, and can eliminate or reduce problems related to the gateway solution.

According to some embodiments, however, when user equipment gets a public/external IP address from a public/external STUN relay server, the user equipment may use this address for non-IMS access to an IP network such as the Internet, or to gain IMS access to an IMS server, such as registering to the IMS with the acquired IP address and establish an IMS session using the IP address. For example, in a broadband access case, typically utilizing network address translation traversal methods, the access gateway may have no ability to separate the non-IMS access of the user equipment and the IMS access of the user equipment from each other. Both, therefore, will flow through the same gateways, and no gating or policy control and flow based charging can be applied to an access to IMS services. This is due to the fact that if there were, non-IMS accesses of the user equipment would be blocked by closed gates or non-existing IP flow filters.

Additionally, the AF/P-CSCF, getting the public/external IP address allocated by the public/external STUN relay server, can not find a policy and charging rules function (PCRF) with the available information. Consequently, the AF/P-CSCF can not send session information and parameters to the PCRF. Additionally, the PCRF can not send policy and/or charging rules to the policy and charging enforcement function (PCEF). Additionally, these configurations can make it difficult for the PCEF to access the IMS session related media streams flowing through the PCEF when a STUN relay is used. The media streams are transferred between the NAT device and the STUN relay in IP packets or IP frames, which is referred to, for example, in the IETF draft currently known as draft-IETF-behave-turn-02, and the addresses of which are not known by the AF/P-CSCF or PCRF or PCEF. These devices can only obtain the public/external address of the user equipment as allocated by the STUN relay.

According to certain embodiments of the present invention, however, the STUN relay or server can allocate public/external addresses to the user equipment in such a way that they are IMS-specific. In other words, the STUN relay discovery mechanisms, which is the way the user equipment finds the STUN relay IP address, advertises the STUN relay as an IMS STUN relay in order to make the user equipment use this particular STUN relay only for IMS sessions. If this is improperly tried for another session, the closed gates/filters will prevent media flow. Since the STUN relay is, according to this configuration, appearing to be IMS access or IMS service related, the discovery mechanisms can be related to or integrated with the finding of P-CSCF. However, other methods such as the use of DNS with proper advertising of this STUN relay being IMS related, can suffice.

According to this configuration, address domains used by the server for allocating public addresses to the user equipment are made IMS-specific; in other words, these addresses are allocated to the user equipment only for IMS sessions.

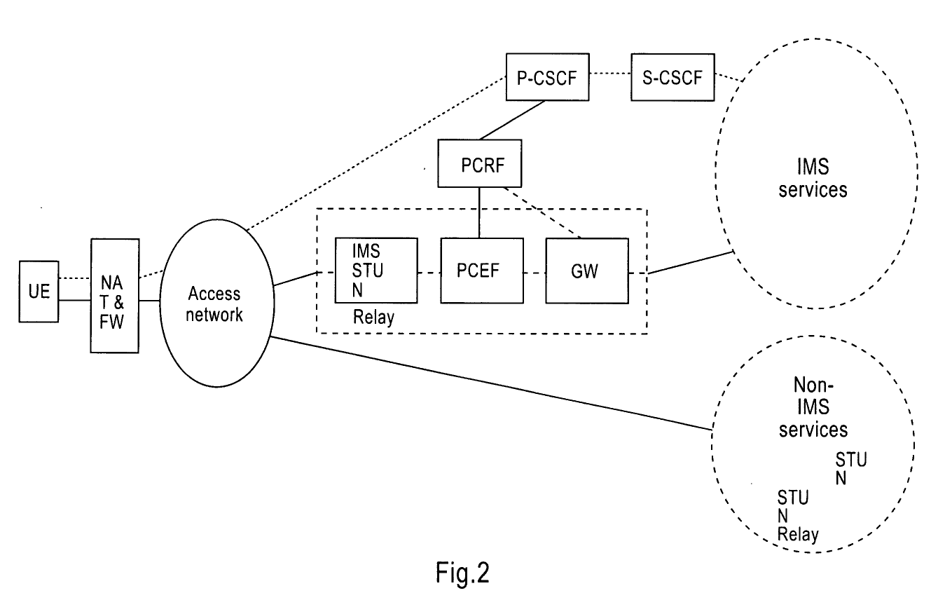

As illustrated in FIG. 2, the IMS specific STUN relay is disposed between the PCEF and the access network. In FIG. 2, the media traffic from the access network address translation device and the firewall (FW) is routed to the STUN relay. Traffic is then routed to the PCEF based upon the public/external address domain controlled by the IMS STUN relay, the address domain being IMS access or IMS service specific and IMS STUN relay specific. Similarly, the media traffic coming from the external/public network to IP addresses belonging to the public/external address domain controlled by the IMS STUN relay is routed via a broader gateway or a router through the PCEF to the STUN relay, and then through the network address translation device to the user equipment.

Using this configuration, the PCEF can access the IMS media flows according to the normal procedures to perform policy and charging control. The AF/P-CSCF gets the public/external IP addresses and ports, as allocated by the IMS STUN relay server to the user equipment, according to SIP/SDP procedures during the establishment of the session. Non-IMS traffic, therefore, is not routed through the PCEF, since the non-IMS traffic does not obtain external/public IP addresses from the IMS STUN relay's IMS access or IMS service specific address domain; addresses are obtained from other STUN relay servers which are not advertised as being IMS specific.

According to certain embodiments of the present invention, therefore, a STUN relay can be configured to use a public/external address area reserved for and allocated to and used specifically for IMS purposes. Additionally, independent of the STUN relay discovery mechanism which is used, the STUN relay can be advertised as an IMS STUN relay. The STUN relay can therefore be configured to route the outbound and uplink traffic via a policy and charging enforcement function (PCEF). The inbound/downlink traffic to IP addresses of the above-mentioned public/external address area can be routed at a border gateway to the related STUN relay through a PCEF. The IMS STUN relay, the PCEF, and the border gateway can be separate physical elements, or can be integrated into one or two elements. For example, all of these functionalities can, for example, be integrated in an IMS controlled gateway, as illustrated for example in FIG. 2. Additionally, the AF/P-CSCF and PCRF can control the PCEF, to thereby apply policy and charging control based on the SDP/Session parameters.

As a result of various configurations of the invention, simultaneous use of the policy and charging control function and the STUN relay for IMS access side network address translation traversal can be enabled. The STUN relay can act as the major network address translation and firewall traversal mechanism; the invention can be implemented in various combinations of hardware and/or software, without requiring specialized configuration changes.

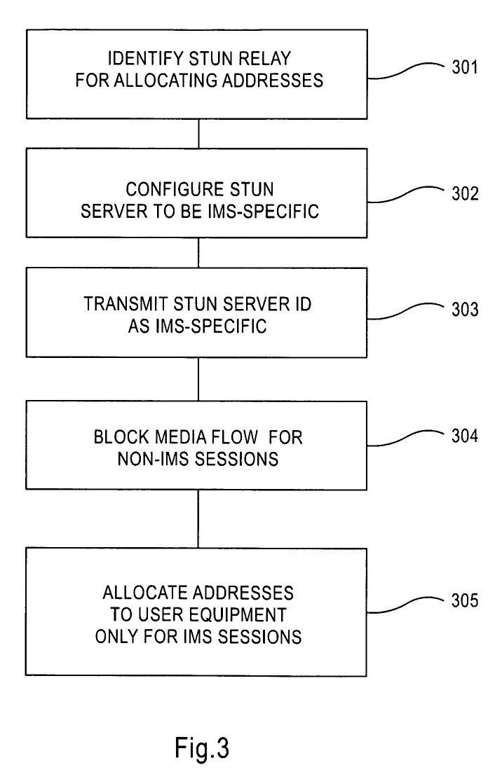

In one embodiment of the invention as illustrated in FIG. 3, a method can include, at 301, identifying a STUN relay or STUN relay server which would be used for allocating addresses. At 302, this STUN server is configured to be IMS-specific. At 303, data relating to this STUN server is transmitted or advertised as the STUN server being for IMS sessions only. At 304, media flow for non-IMS sessions is blocked. At 305, the STUN server allocates public addresses to the user equipment only for IMS sessions.

The method illustrated in FIG. 3 can allocate addresses independent of the particular STUN relay discovery mechanism which is used. The STUN server is advertised as being an IMS STUN relay.

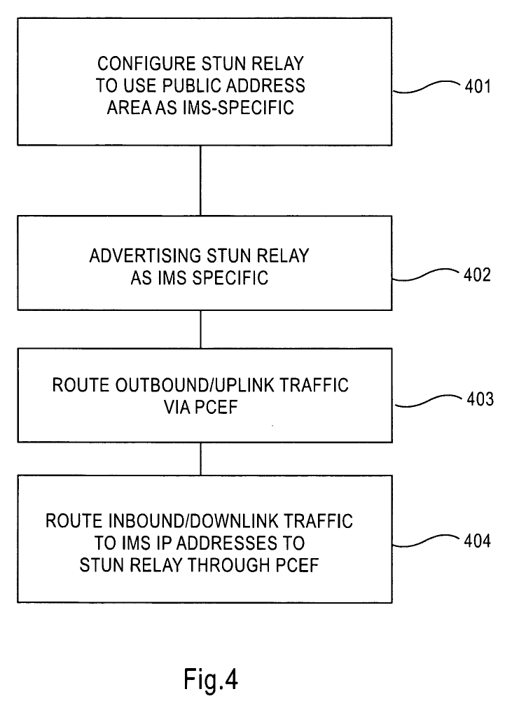

Another embodiment of the invention is illustrated in FIG. 4. At 401, a STUN relay/server is configured to use a public/external address area for IMS purposes. At 402, this STUN relay is advertised through an appropriate discovery mechanism as being an IMS STUN relay or server. At 403, the STUN relay/server was configured to route outbound/uplink traffic via PCEF. At 404, inbound/downlink traffic to IP addresses from the address area is routed at a border gateway, to the related STUN relay through a PCEF.

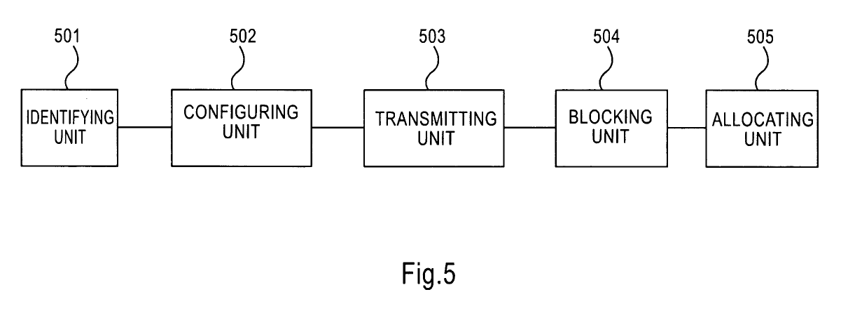

Another implementation of the invention is illustrated in FIG. 5. In FIG. 5, identifying unit 501 can identify a STUN relay for allocating addresses. The identifying unit can be a separate physical element, or can be a virtual element implementing a combination of hardware and software. Configuring unit 502 configures the identified STUN server to be IMS specific. Transmitting unit 503 can transmit a notice or otherwise advertise the STUN server as being IMS specific. A blocking unit 504 can then block media flow for non-IMS sessions, and allocating unit 505 can allocate IP addresses from an address area to the user equipment only for IMS sessions. It should be noted that the various units of FIG. 5 can be physically separate units, or can be a series of functionalities which are integrated into a single processor or various elements. For example, as illustrated in FIG. 2, an IMS STUN relay, a PCEF, and a border gateway can be integrated into an IMS gateway.

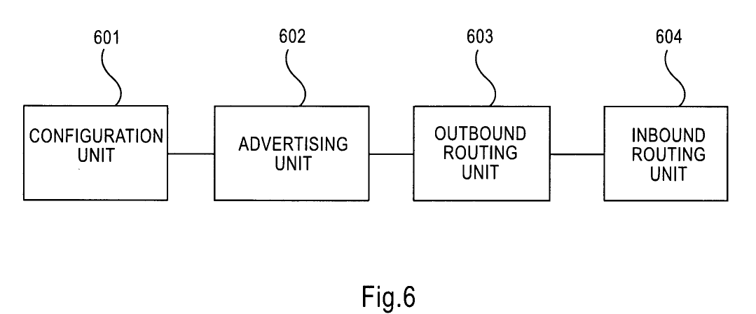

FIG. 6 illustrates another embodiment of the invention. As discussed above with respect to FIG. 5, the elements of FIG. 6 can be implemented as separate physical elements, or can be implemented with other elements as a combination of hardware and software, pure hardware, or pure software running on a processor. The processor can be located in a user equipment, in a STUN server, or any other of a plurality of network components.

According to FIG. 6, configuration unit 601 configures a STUN relay to use a public/external address area for IMS sessions or IMS purposes only. Advertising unit 602 advertises the STUN relay as IMS specific. Outbound routing unit 603 routes outbound/uplink traffic at a border gateway to the related STUN relay through a policy and charging enforcement function. Inbound routing unit 604 routes inbound/downlink traffic which have the destination addresses in the above-noted address area are routed to the STUN relay through a policy and charging enforcement function.

As a result of the various configurations of the invention, effective and efficient handling of IMS traffic can occur, without requiring a user equipment to first send a media packet in order to have the network address translation device allocate a particular address, and also for modifying the gateway to obtain the address and use it as a destination address for downlink media packets. Additionally, the configurations of the present invention can reduce or eliminate the need for various applications to send keep-alive messages when there is no traffic. Additionally, overall network congestion can be further reduced and transmission delays minimized due to the fact that there is no need to loop a media pass via a home network.

As discussed above, various embodiments of the invention can be configured in numerous physical elements, or can be configured at a single network element or configured in a number of elements having various disclosed functions distributed throughout. The control of the identification, configuration, transmitting, blocking, allocating, and other functions can be performed at various network components, such as at a user equipment, at a STUN relay server, at an access gateway or at another network component associated with IMS access.

A person of ordinary skill in the art would understand that the above-discussed embodiments of the invention are for illustrative purposes only, and that the invention can be embodied in numerous configurations as discussed above. Additionally, the invention can be implemented as a computer program on a computer readable medium, where the computer program controls a computer or a processor to perform the various functions which are discussed as method steps and also discussed as hardware or hardware/software elements.

In the above description of the various embodiments of the present application, one or more of the following abbreviations may be used:

| | |
|---|---|
| 3GPP | 3^{rd} generation partnership project |
| AF | Application function |
| ALG | Application level gateway |
| CN | Core network |
| CSCF | Call session control function |
| FW | Firewall |
| GW | Gateway |
| ICE | Interactive connectivity establishment |
| IETF | Internet engineering task force |
| IM | IP multimedia |
| IMS | IP multimedia subsystem |
| IP | Internet protocol |
| MGW | Media gateway |
| NAT | Network address translation |
| P-CSCF | Proxy call session control function |
| PCEF | Policy and charging enforcement function |
| PCRF | Policy and charging rules function |
| PLMN | Public land mobile network |
| PS | Packet switched |
| SDP | Session description protocol |
| SIP | Session initiation protocol |
| STUN | Simple Traversal of User Datagram Protocol (UDP) through |
| | Network address translations (NATs) |
| TISPAN | Telecommunications and Internet Converged Services and |
| | Protocols for Advanced Networking |
| TR | Technical report |
| TS | Technical specification |
| UE | User equipment |

What is claimed:

1. A method, comprising:
a communications server transmitting identification information to a network, wherein the transmitted identification information identifies to the network that the communication server is directed to a first type of communications;
receiving data related to a session comprising the first type of a first type of communications; and
blocking media flow for a session comprising a second type of communications.

2. The method of claim 1, wherein said first type of communications is specific to an internet protocol multimedia subsystem.

3. The method of claim 1, further comprising:
allocating an address to a user equipment in said network for said session comprising the first type of communications.

4. The method of claim 1, wherein the communications server is configured for a simple traversal of a user datagram protocol through a network address translation.

5. The method of claim 1, further comprising:
enabling first traffic comprising the second type of communications when second traffic comprising the first type of communications is not detected for a prespecified period of time.

6. A method, comprising:
using a public address area of a communication relay for functions specific to an internet protocol multimedia subsystem; and
advertising to components of a network that the relay is specific to the internet protocol multimedia subsystem.

7. The method of claim 6, wherein the communication relay is configured for a simple traversal of a user datagram protocol through a network address translation.

8. The method of claim 6, further comprising routing outbound/uplink traffic from the relay through a policy and charging enforcement function.

9. The method of claim 6, further comprising routing inbound/downlink traffic through a policy and charging enforcement function and via the relay to addresses in the internet protocol multimedia subsystem.

10. The method of claim 6, further comprising:
using the public address area for functions unrelated to the internet protocol multimedia subsystem when traffic related to the internet protocol multimedia subsystem is not detected for a prespecified period of time.

11. A network component, comprising:
an identifying unit configured to identify a function-specific relay for allocating addresses;
a configuring unit configured to configure the identified relay to implement tasks related to a internet protocol multimedia subsystem;
a transmitting unit configured to transmit or advertise to a user equipment that the relay is related to the internet protocol multimedia subsystem;
a blocking unit configured to block media flow for a first session unrelated to the internet protocol multimedia subsystem; and
an allocating unit configured to allocate an internet protocol address from an address area to the user equipment, wherein said internet protocol address is only used for a second session related to said internet protocol multimedia subsystem.

12. The network component of claim 11, wherein the function specific relay is configured for a simple traversal of a user datagram protocol through a network address translation.

13. The network component of claim 11, wherein the transmitting unit is further configured to route outbound/uplink traffic from the relay through a policy and charging enforcement function.

14. The network component of claim 11, wherein the transmitting unit is further configured to route inbound/downlink traffic through a policy and charging enforcement function and via the server/relay to the allocated address in the internet protocol multimedia subsystem.

15. The network component of claim 11, further comprising:
a time-out unit configured to reconfigured the relay to enable traffic unrelated to the internet protocol multimedia subsystem if there has been no traffic related to the internet protocol multimedia subsystem for a period of time.

16. A network element, comprising:
a configuration unit configured to configure a relay to use a public/external address area for only for sessions related to an internet protocol multimedia subsystem;
an advertising unit is configured to advertise the relay as specific to the internet protocol multimedia subsystem;
an outbound routing unit configured to route outbound/uplink traffic at a border gateway to the relay through a policy and charging enforcement function; and
an inbound routing unit routes inbound/downlink traffic which has the destination addresses in the address area to the relay from the policy and charging enforcement function.

17. The network component of claim 16, wherein the relay is configured for a simple traversal of a user datagram protocol through a network address translation.

18. The network component of claim 16, further comprising:
a time-out unit configured to reconfigure the relay to enable sessions unrelated to the internet protocol multimedia subsystem when there has been none of the sessions related to the internet protocol multimedia subsystem for prespecified period of time.

19. A method, comprising:
receiving identification information related to a communications server, wherein the transmitted identification information identifies that the communication server is directed to a first type of communications, wherein said first type of communications is specific to an internet protocol multimedia subsystem;
transmitting data related to a session comprising the first type of a first type of communications;
receiving from the server an allocated network address specifically designated for said session comprising the first type of communications; and
transmitting to said address data related to said session.

20. A user equipment configured to:
receive identification information related to a communications server, wherein the transmitted identification information identifies that the communication server is directed to a first type of communications, wherein said first type of communications is specific to an internet protocol multimedia subsystem;
transmit data related to a session comprising the first type of a first type of communications;
receive from the server an allocated network address specifically designated for said session comprising the first type of communications; and
transmit data related to said session using said received address.
